(19) United States
(12) Patent Application Publication
(10) Pub. No.: US 2008/0188174 A1
(43) Pub. Date: Aug. 7, 2008

(54) Power system for a building structure

(76) Inventors: Rouzbeh Aminpour, Irvine, CA (US); Marc Gaddis, Long Beach, CA (US)

Correspondence Address: Myers Dawes Andras & Sherman LLP, Suite 1150, 19900 MacArthur Blvd., Irvine, CA, 92612, US

(21) Appl. No.: 11/701,328

(22) Filed: Feb. 1, 2007

(51) Int. Cl. F24F 7/00; F24F 13/08; H02P 9/04; F03D 9/00

(52) U.S. Cl. 454/309; 290/55; 290/1 R; 290/50

(57) ABSTRACT

An electrical generation system is adapted for use with an HVAC system to adjust the louvers of a shutter disposed to control a flow of air into the room of a house. The generation system includes a wind generator disposed in a duct of the HVAC system and having properties for generating electricity. This electricity is collected for use in powering a motor to adjust the louvers of the shutter. The wind generator includes a turbine which powers a generator to produce the electricity. Ultimately the electricity can be controlled to adjust the louvers of the shutter from a remote location.

### BACKGROUND OF THE INVENTION

1. Field of the Invention

This invention relates generally to systems for generating and using power with respect to a building structure, and more specifically to an embodiments adapted for use with a heating, ventilating, air conditioning system.

2. Discussion of the Prior Art

The power requirements of building structures, such as houses, commercial buildings, and even barns, are well known. These power requirements are typically met by large electrical distribution systems provided and maintained by governmental agencies. In some instances, large generators have been provided in proximity to the building structures, to accommodate large loads and otherwise to provide electricity when no other source is available. While self-generated power may be less expensive, it is typically less reliable than government supplied power. Both of these power systems require complex wiring systems to deliver electrical power to several sites that may be of interest in and around the building structure.

Notwithstanding these large power systems, there remain specific power requirements at various sites in the building structure where power is not present. These are typically sites where power is not available and the significant cost of bringing power to the site is to be avoided.

Against this background it can be appreciated that many building structures, particularly houses have several rooms that are serviced by a heating, ventilating, air conditioning system (HVAC). Such a system typically includes an HVAC blower that is commonly positioned outside the house, and a series of ducts that extend from the blower to distribute a flow of air to the rooms of the house. Each of the ducts is typically terminated at a register, which is positioned where the flow of air enters the associated room. The registers are commonly provided with louvers that are mechanically moveable between open and closed positions. The setting of these louvers controls the flow of air into the associated room and also affects the flow of air into the other rooms of the house.

These louvers are typically out of reach, very difficult to manipulate, and totally inoperable from a remote location. What is needed is a system for automatically operating the louvers, perhaps from a remote location, in order to set them at a desired position between their open and closed states. Unfortunately building structures are not wired to provide power at the sites of these registers; and the cost of providing such power, particularly in an after-market, is substantial.

### BRIEF SUMMARY OF THE INVENTION

In accordance with the present invention, a power system is provided at a site of need. In the case of the HVAC system, this site would be in proximity to the register associated with a room in the house. In this location, energy in the vicinity of the house can be captured and used to control the louvers of a shutter, such as the register. The system may also include a wireless network making it possible to control the energy for louver adjustment from a remote location.

The energy of interest might include light in visible or invisible spectrums, and even a flow of air such as wind. This energy can then be harnessed, typically converted into electrical energy, and perhaps stored for future use. The energy can then be used to power a mechanical system connected to the shutter for louver adjustment. It will be appreciated that the conversion of the source energy into a more usable form, such as electricity, might involve a sensor, a collector, a storage device such as a battery or capacitor, and the motor. When the ultimate energy desired is other then electricity, these functions could be performed by other devices well known in the art.

In one aspect, the invention relates to an electrical generation system adapted for use with a house having at least one room. An HVAC unit, disposed in proximity to the house, generates a flow of HVAC air that is distributed through a duct to the room. A wind generator is disposed in this flow of air to generate electricity for use with the house. This wind generator is preferably disposed in the duct of the HVAC system, in proximity to the room where the electricity can be used to adjust the louvers of a shutter.

In another aspect of the invention, a wind turbine is disposed in the flow of HVAC air and produces rotary power. A generator responsive to this rotary power generates electricity. Ultimately, a shutter system is responsive to the electricity from the generator to control the flow of the HVAC air into the room. The turbine may have a first shaft and the generator a second shaft that is common with the first shaft in a particular embodiment.

The generator is typically fixed with respect to the HVAC duct and may include at least one coil having a stationary relationship with the duct. Electricity is produced in the coils by a plurality of magnetic disks, which have a rotary relationship with the duct.

In another aspect of the invention an electrical generation system is adapted for use with a house and includes an energy collector disposed to collect energy in proximity to the house. A converter converts this energy into electrical energy. Ultimately means is provided for using this electrical energy for purposes associated with the house. The energy collected can be in various forms, for example, light energy, both visible and invisible, and pneumatic energy such as wind.

These and other features and advantages of the present invention will become more apparent with a description of preferred embodiments and reference to the associated drawings.

### BRIEF DESCRIPTION OF THE DRAWINGS

FIG. 1 is a block diagram of a generic form of the present invention adapted for use in controlling a flow of HVAC air into the room of a building structure;

FIG. 2 is a rear perspective assembly view of a wind generator adapted for use in a specific embodiment of the present invention;

FIG. 3 is a front perspective assembly view of the wind generator illustrated in FIG. 2;

FIG. 4 is a side elevation view of a casing and front shaft holder disposed in the duct of an HVAC system;

FIG. 4A is a front elevation view of the casing and front shaft holder illustrated in FIG. 4;

FIG. 4B is a rear elevation view of the casing and front shaft holder illustrated in FIG. 4;

FIG. 5 is a side elevation view of the front shaft holder in a preferred embodiment of the present invention;

FIG. 5A is a front elevation view of the front shaft holder illustrated in FIG. 5;

FIG. 5B is a rear elevation view of the front shaft holder illustrated in FIG. 5;

FIG. 6 is a side elevation view of a wind generator associated with a preferred embodiment of the present invention;

FIG. 6A is a front elevation view of the wind generator illustrated in FIG. 6;

FIG. 6B is a front elevation view of the wind generator illustrated in FIG. 6;

FIG. 7 is a side elevation view of a shutter associated with a preferred embodiment of the present invention;

FIG. 7A is a front elevation view of the shutter illustrated in FIG. 7;

FIG. 7B is a rear elevation view of the shutter illustrated in FIG. 7;

FIG. 8 is a side elevation of a planetary gear associated with an embodiment of the present invention;

FIG. 8A is a front elevation view of the planetary gear of FIG. 8;

FIG. 8B is a rear elevation view of the planetary gear of FIG. 8;

FIG. 9 is a side elevation view of a rear shaft holder associated with a preferred embodiment of the present invention;

FIG. 9A is a front elevation view of the rear shaft holder illustrated in FIG. 9; and

FIG. 9B is a rear elevation view of the rear shaft holder illustrated in FIG. 9.

### DETAILED DESCRIPTION OF PREFERRED EMBODIMENTS

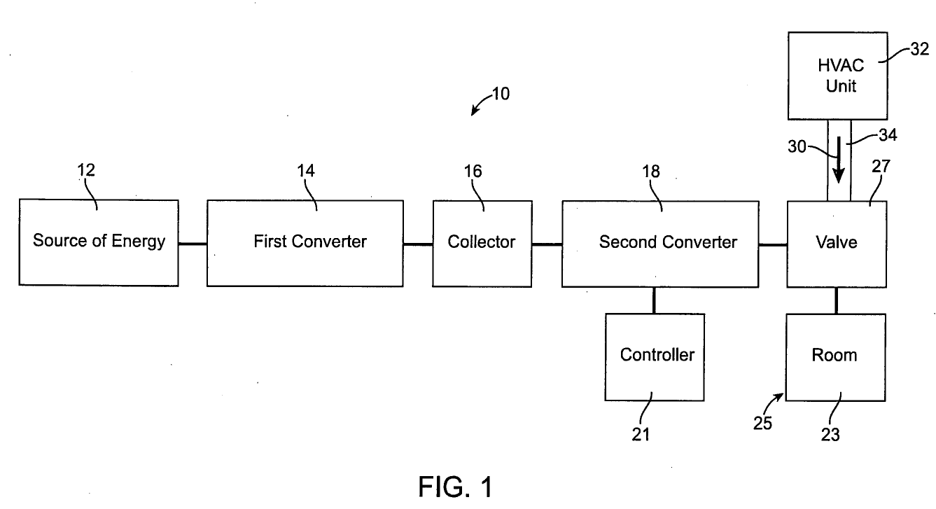

An energy system is illustrated in FIG. 1 and designated by the reference numeral 10. FIG. 1 is a block diagram which illustrates a generic form of the invention that is not dependent on the type of energy involved nor the specific nature of its intended use. Thus, FIG. 1 illustrates a source of energy 12 which may include potential energy or kinetic energy. The energy may be radiant energy such as light energy in the visible or invisible spectrums. It might also be heat energy, or generally any energy in any form.

This energy from the source 12 can be introduced to a first converter 14, which transforms the source energy into a secondary form of energy, such as electricity. The energy from the converter 14 can be used directly, or introduced to an energy storage device or collector 16 where it can be stored for future use. The output of the collector 16 can be transformed in a second converter 18 to a third type of energy such as mechanical energy. This conversion can take place immediately or at a more convenient time under the action of a remote controller 21.

By way of example, the converter 18 may be an electric motor responsive to the electricity produced by the converter 14 and accumulated by the collector 16. The mechanical energy produced by the converter 18 can be used for many purposes associated with a room 23 of a house 25. In the example illustrated in FIG. 1, the mechanical energy from the converter 18 is used to open a mechanical valve 27 for controlling a flow of fluid into the room 23. More specifically, a flow of air 30 is produced by an HVAC unit 32 and distributed to the room 23 through a duct 34. This air flow 30 passes through the valve mechanism, which may take the form of a register or a shutter having louvers. In this example, the mechanical energy from the converter 18 can be used to move the shutter between an open position and a closed position to meter the flow of the HVAC air 30 into the room 23.

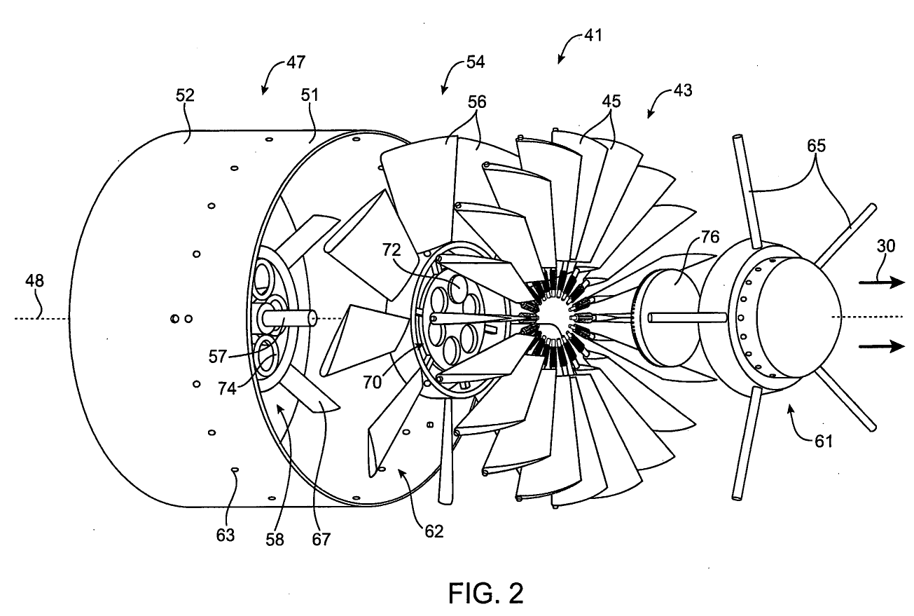

A more specific embodiment of the invention is illustrated in the perspective assembly drawing of FIG. 2. In this view, the various parts of a wind generator 41 are shown in combination with a shutter 43 having louvers 45. This combination is housed in a casing 47 having a rear end 51 facing downstream in the direction of the HVAC unit 32 (FIG. 1) and a front end 52 facing upstream in the direction of the room 23 (FIG. 1). In this embodiment, the casing 47 is generally cylindrical about an axis 48.

The wind generator 41 includes a turbine 54 having fan blades 56. A common shaft 57 supports the turbine 54 and the shutter 43 within the casing 47. The shaft 57 is in turn supported by a front shaft holder 58 and a rear shaft holder 61, both of which are anchored within the casing 47 along the axis 48.

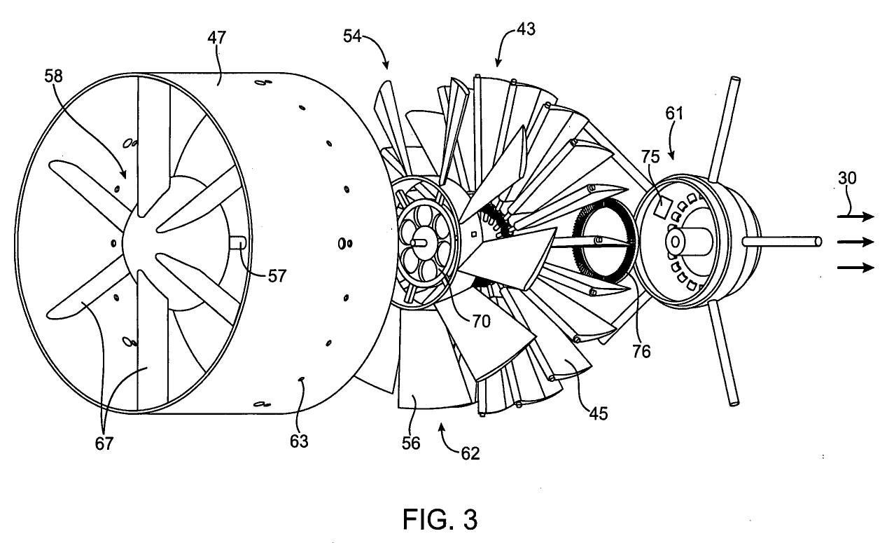

The rear shaft holder 61 is fixed along the axis 48 by a plurality of rear spokes 65, which radiate outwardly from the rear shaft holder 61 to engage holes in the casing 47. The front shaft holder 58 can be similarly anchored by front spokes 67, which radiate outwardly from the front shaft holder 58 to engage the casing 47. These front spokes 67 are best illustrated in FIG. 3, which shows a perspective assembly view taken from the end opposite to that shown in FIG. 2, the front end, of the wind generator 41.

From these two views of FIG. 2 and FIG. 3, it can be seen that the generator 62 in this embodiment includes a magnet receiver 70 that is adapted to hold a plurality of permanent magnets 72. The generator 62 also includes a plurality of coils 74 that are housed in the front shaft housing 58. In operation, the turbine 54 rotates the magnets 72 in close proximity to the coils 74 in order to produce the electricity that emanates from the controller 14 (FIG. 1).

At the opposite end of the wind generator 41, the rear shaft holder 61 is adapted to receive a motor 75 (FIG. 2), which drives a planetary gear 76 to rotate the individual louvers 45 associated with the shutter 43 to any position between a closed position and an open position.

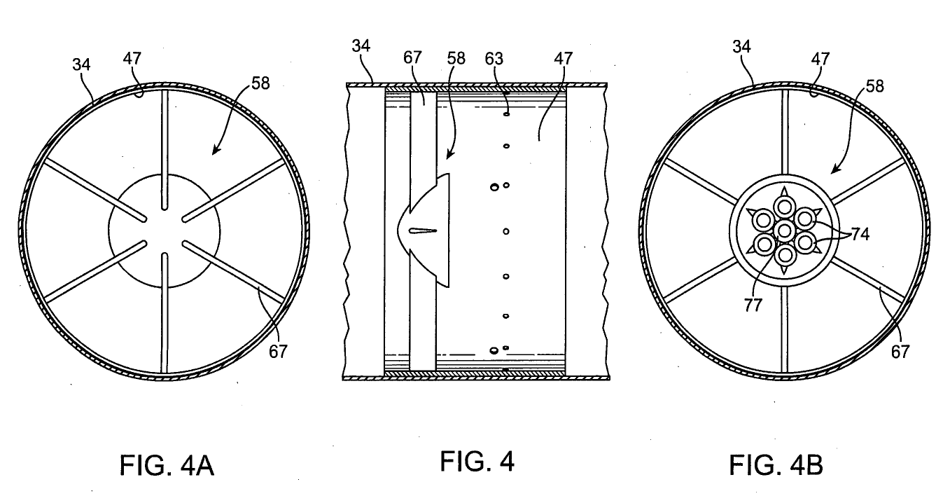

Referring now to FIG. 4, the casing 47 is illustrated in greater detail within the HVAC duct 34. The duct 34 may have any cross sectional shape or area. It is not unusual in both commercial buildings and houses for the duct to include portions with a cross sectional shape and other portions with a circular shape. Since the wind generator 41 can be disposed at any location along the duct 34, it is merely important that the casing 47 have a cross section that mimics the shape of the duct 34 at that location. Accoringly, the perimeter of the casing 47 is preferably closely adjacent to the walls of the duct 34 so that substantially all of the air flow 30 passes through the casing 47.

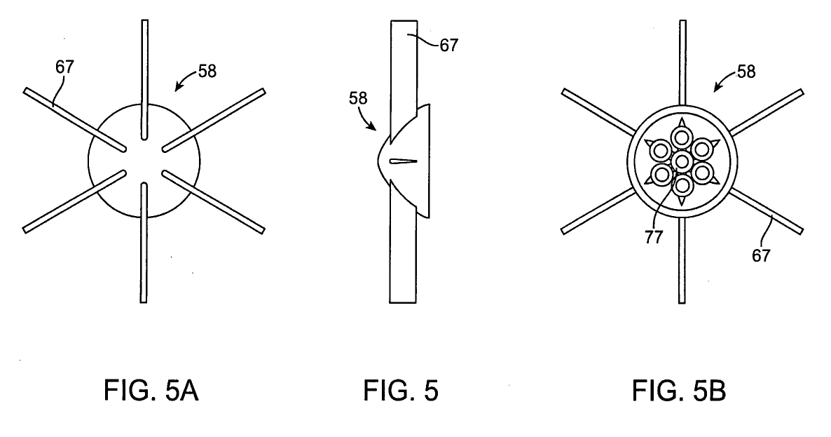

The front shaft holder 58 is also illustrated in FIG. 4 where the spokes 67 are shown to be anchored to the casing 47. This shaft holder 58 is best shown in the front and rear views of FIGS. 4A and 4B, respectively. The holes 63 are also illustrated in the side view of FIG. 4. It is these holes 63, which are sized to receive projections on the outer edges of the louvers 45, as described in greater detail below. The side view of FIG. 5 together with the front and rear views of FIGS. 5A and 5B, also show the front shaft holder 58.

Of particular interest in FIG. 4B is a hub 77 that is sized to receive the shaft 57. Disposed around this hub 77 are the coils 74, which number six in the illustrated embodiment. These coils 74 are closely spaced to the magnets 72 carried in the receiver 70. As the rotating flux field is created by the magnets 72, electrical current is induced in the coils 74 in a manner well known in the art. These coils 74 can be connected in series, parallel, or in a three-phase delta or Y configuration, to provide the desired output for the wind generator 41.

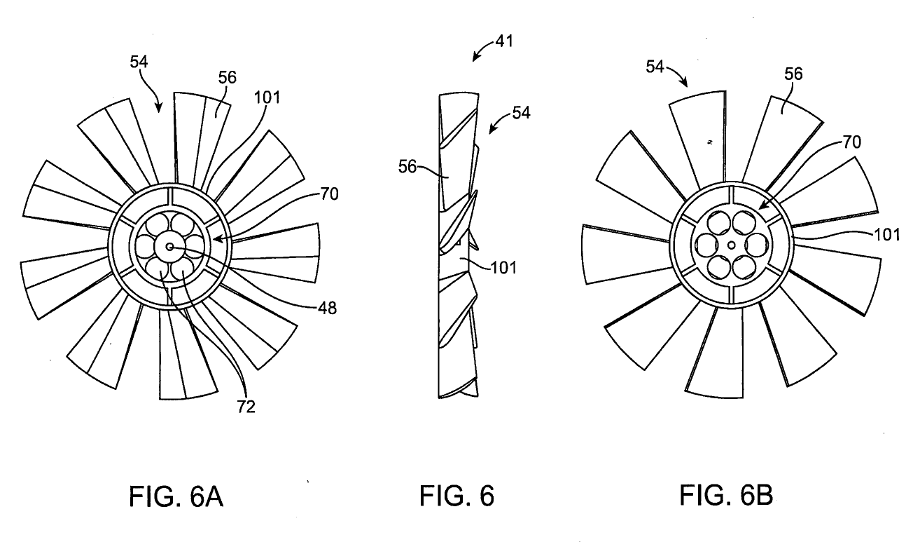

The wind generator 41, including the turbine 54 and portions of the generator 62, is illustrated in the side view of FIG. 6, the front view of FIG. 6A, and the rear view of FIG. 6B. In these views, the fan blades 56 are shown to have a fixed relationship with a cylindrical wall 101. Centered within the cylindrical wall 101 is the receiver 70 and portions thereof that are sized to receive the common shaft 57. The turbine 54 is free to rotate on the shaft 57 in a plane generally perpendicular to the axis 48.

The receiver 70 is suitably apertured to receive the plurality of permanent magnets 72, which number six in the illustrated embodiment. In response to the flow of air 30 through the blades 56, the turbine 54 rotates the receiver 70 and associated magnets 72 about the axis 48. This produces a rotating flux field in proximity to the coils 74 housed in the front shaft holder 58, thereby inducing the electricity in the coils 74 that is ultimately output from the generator 62. Thus the magnets 72 in the receiver 70 form a rotor, and the coils 74 form a stator in the common configuration of a generator.

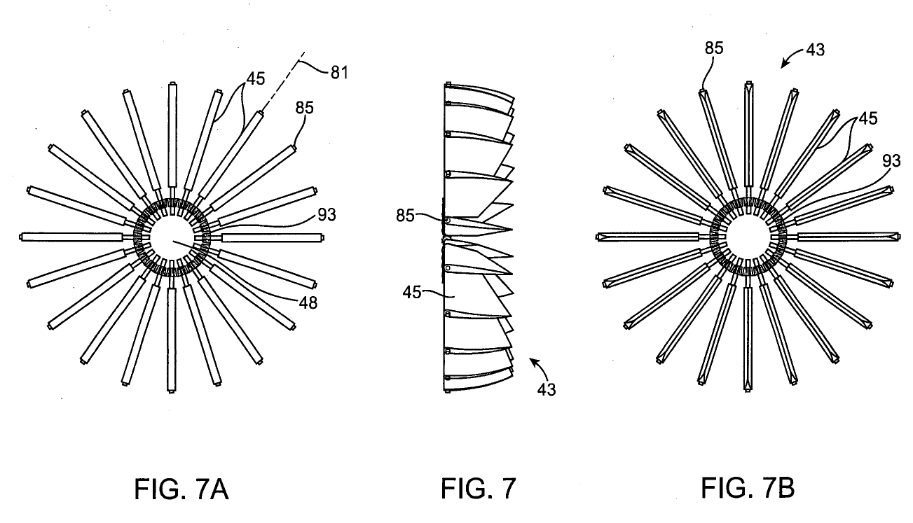

A side view of the shutter 48 is illustrated in FIG. 7 along with its louvers 45. The detail associated with the louvers 45 is best shown in the front view of FIG. 7A and the rear view of FIG. 7B. Thus it can be seen that each of the louvers 45 extends on a pivotal axis 81, which radiates outwardly from the casing axis 48 to a small projection 85. It is this projection 85 that is adapted to be received in an associated one of the holes 63 in the casing 47. In this embodiment, each of the louvers 45 is provided with a small gear 93, which can be rotated to move the associated louver 45 between its open and closed positions.

The converter 18 (FIG. 1) in this embodiment may comprise a motor 75 disposed within the rear shaft holder 61 along with a capacitor or battery 94 that forms the collector 16 (FIG. 1) in this embodiment. The planetary gear 76 is also carried within the rear shaft holder 61 where it engages the individual gears 93 associated with each of the louvers 45. In operation, the electrical energy provided by the battery 94 in this embodiment drives the motor 75 to move the planetary gear 76 thereby causing each of the individual gears 92 to rotate their respective louvers 45 between the open and closed positions.

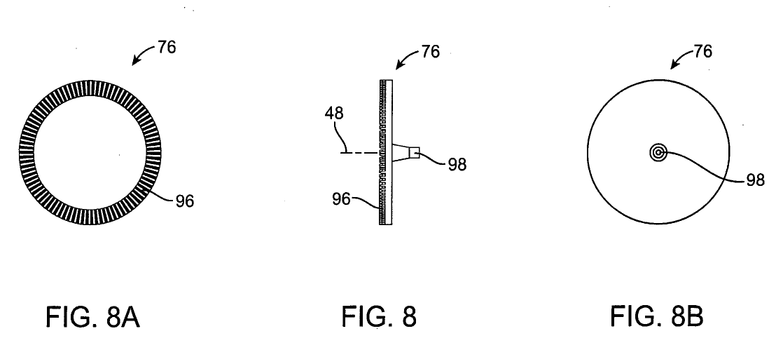

FIGS. 8, 8A and 8B illustrate the planetary gear 76 that was first discussed with reference to FIGS. 2 and 3. The planetary gear 76 in this embodiment of the invention includes a gear surface 96 and a hub 98. The hub 98 is adapted for mounting on the shaft 57 to facilitate rotation of the gear 76 and the gear surface 96, about the axis 48. The hub 98 is positioned along the shaft 57 where it engages the individual gears 93 associated with the louvers 45. In operation, the gear 76 is driven by the motor 75 to rotate the gear surface 96 about the axis 48. This causes the gears 93 of the louvers 45 to individually rotate on their axes 81 to move the louvers 45 and the shutter 43 to any position between the open and closed positions.

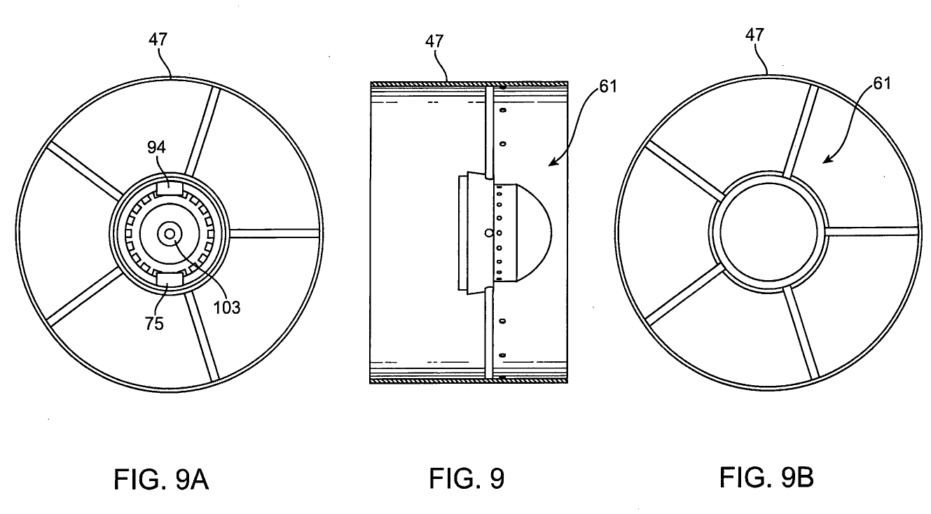

Referring now to FIG. 9, the rear shaft holder 61 is illustrated in a side view, with a front view shown in FIG. 9A and a rear view shown in FIG. 9B. Of particular interest in the rear shaft holder 61 is a hub 103 which is sized and configured to receive the rear end of the shaft 57. In the illustrated embodiment, the motor 75 and battery 94 are disposed around this hub 103 within the rear shaft holder 61.

With further reference to FIG. 9, it can be seen that a portion of the cross section of the casing 47 is taken up by the rear shaft holder 61. The remaining cross sectional area, between the rear shaft holder 61 and the casing 47, is substantially reduced from the area that immediately precedes the rear shaft holder 61. This reduction in cross sectional area results in a Venturi effect so that the flow of air 30 upstream of the rear shaft holder 61 has an increased velocity. It is this faster moving air that ultimately contacts the wind generator 41 to facilitate the production of electricity.

The illustrated embodiment is configured to accommodate an HVAC system where the source of energy is the HVAC unit 32. The energy in the flow of air 30 is harnessed by the wind generator 41 (the converter 14 in FIG. 1). Electricity from the wind generator 41 is gathered in the battery 94 (the energy storage device or collector 16 in FIG. 1), where it is stored for future use. This energy stored in the battery 94 is used to drive the motor 74 (the converter 18 in FIG. 1), which rotates the louvers 45 of the shutter 43 between the open and closed positions.

It will be apparent, particularly with reference to FIG. 1, that the energy provided by the source 12 may be other than a flow of air 30. For example, the source 12 may comprise radiated energy that is easily converted to electricity, collected, and used to drive a motor for the same or some other purpose associated with the house 25. In this case the converter 14 might take the form of a light sensor responsive to light in any of the light spectrums. Other sources of potential or kinetic energy in various forms could be similarly used for a purpose associated with the house 25.

1. An electrical generation system adapted for use with a building structure having at least one room, the generation system comprising:
an HVAC unit disposed in proximity to the building structure for generating a flow of HVAC air;
a duct providing communication between the HVAC unit and the building structure, the duct terminating in the room of the building structure and having properties for directing at least a portion of the HVAC air into the room; and
a wind generator disposed in the flow of the HVAC air and having properties responsive to the flow of HVAC air to generate electricity for use with the building structure.

2. The electrical generation system of claim 1 wherein the wind generator is disposed in the duct.

3. The wind generation system of claim 2 wherein the wind generator is disposed in proximity to the room.

4. The wind generation system recited in claim 3, further comprising:
a shutter disposed in proximity to the wind generator and being moveable between a first position wherein the shutter is closed to block the flow of the HVAC air into the room, and a second position wherein the shutter is open to facilitate a flow of the HVAC air into the room.

5. The electrical generation system recited in claim 4 wherein the shutter is disposed downstream of the wind generator in proximity to the wind generator.

6. The electrical generation system recited in claim 5 wherein the shutter forms a register disposed to terminate the duct in the room.

7. The electrical generation system recited in claim 5 wherein the shutter is disposed generally perpendicular to the flow of HVAC air in the duct.

8. The electrical generation system recited in claim 4, further comprising:
a plurality of louvers included in the shutter; and
a motor responsive to the electricity generated by the wind generator for moving the louvers of the shutter between the first position and the second position.

9. The electrical generation system recited in claim 7 wherein the shutter is disposed to receive the entire flow of HVAC air in the duct.

10. An electrical generation system adapted for use with a building structure having at least one room, the generation system comprising:
an HVAC unit disposed in proximity to the building structure for generating a flow of HVAC air;
a duct providing communication between the HVAC unit and the building structure, the duct terminating in the room of the building structure and having properties for directing at least a portion of the HVAC air into the room;
a wind turbine responsive to the flow of HVAC air to produce rotary power;
a generator responsive to the rotary power of the turbine to generate electricity; and
a shutter responsive to the electricity generated by the generator for controlling the flow of the HVAC air into the room.

11. The electrical generation system recited in claim 10, wherein:
the turbine includes a first shaft having a first axis of rotation; and
the generator includes a second shaft having a second axis of rotation.

12. The electrical generation system recited in claim 11 wherein the first axis of the first shaft is coincident with the second axis of the second shaft.

13. The electrical generation system recited in claim 12 wherein the first shaft is common with the second shaft.

14. The electrical generation system recited in claim 10 wherein the duct has a generally cylindrical wall, and the system further comprises:
a housing forming a conduit having a generally cylindrical walls disposed in proximity to the wall of the duct so that substantially all of the HVAC air flowing in the duct passes through the conduit; and
means for mounting the turbine and the generator inside of the conduit.

15. The electrical generation system recited in claim 10, wherein the generator further comprises:
at least one coil having a stationary relationship with the conduit and being disposed generally in a first plane;
a plurality of magnetic disks having a rotary relationship with the conduit and having properties for producing a rotating flux field oriented in a second plane generally perpendicular to the first plane to produce electrical energy in the coil.

16. The electrical generation system recited in claim 15, further comprising:
a collector coupled to the coil of the generator for storing the electrical energy received from the coil.

17. The electrical generation system recited in claim 16 wherein the collector comprises a battery.

18. The electrical generation system recited in claim 16 wherein the collector comprises a capacitor.

19. An electrical generation system adapted for use with a building structure, comprising:
an energy collector disposed in the building structure for collecting energy in the vicinity of the building structure;
a converter for converting the energy of the collector into electrical energy; and
means for using the electrical energy converted by the converter for purposes associated with the building structure.

20. The electrical generation system recited in claim 19 wherein the energy collected in the house is light energy.

21. The electrical generation system recited in claim 19 further comprising a sensor disposed in the building structure for collecting the light energy in the building structure and for converting the light energy in the building structure into the electrical energy.

22. The electrical generation system recited in claim 19 wherein the energy collected in the house is pneumatic energy.

23. The electrical generation system recited in claim 22, further comprising a wind generator responsive to the moving air in the HVAC duct in the building structure to convert the energy of the moving air into electrical energy.

24. The electrical generation system recited in claim 19 further comprising:
means for storing the electrical energy converted by the converter.

25. The electrical generation system recited in claim 24 wherein the storage means comprises at least one of a capacitor and a battery.

26. The electrical generation system recited in claim 19 wherein the using means comprises a motor adapted to control a flow of the energy in the building structure.
